(19) United States
(12) Patent Application Publication
(10) Pub. No.: US 2026/0124477 A1
(43) Pub. Date: May 7, 2026

(54) HARNESS AND METHOD

(71) Applicant: SKYLOTEC GmbH, Neuwied (DE)

(72) Inventors: Gianluca BRIOSCHI, Gorgonzola (IT); Rebecca DAL CANTO, San Leo (IT)

(21) Appl. No.: 19/370,355

(22) Filed: Oct. 27, 2025

(30) Foreign Application Priority Data
Oct. 30, 2024 (EP) 24209936.4

(51) Int. Cl. A62B 35/00

(52) U.S. Cl. CPC A62B 35/0006

(57) ABSTRACT

A harness includes a belt loop, a leg loop, and a belay connection structure that includes at least one ring-like element; at least one tubular element, wherein one of the belt loop and the leg loop together with a circumferential section of the at least one ring-like element extend through the at least one tubular element, and wherein the at least one tubular element extends along a length that equals more than half of a circumferential length of the at least one ring-like element; and a belay connection element connecting the belt loop and the leg loop with each other and extending through the at least one ring-like element.

### CROSS-REFERENCE TO RELATED APPLICATIONS

The present application is based upon and claims the right of priority to EP Patent Application No. 24209936.4, filed on Oct. 30, 2024, the disclosure of which is hereby incorporated by reference herein in its entirety for all purposes.

### FIELD OF INVENTION

The invention relates to harness comprising a belt loop, a leg loop, and a belay connection element connecting the belt loop and the leg loop with each other. The invention further relates to a method.

### BACKGROUND

A part of safety equipment is designated as a harness, which is worn on a body of a person during climbing, ski touring, mountaineering, via ferrata, tree maintenance, or during work with a risk of falling, and through which a connection is established between the person to be secured and, for example, a safety device to prevent falls or a tie in point.

The harness is typically made from several loops, which are placed around the middle of the body as belt loop respectively hip belt and around legs of the person as leg belts. The loops are brought together at a tie in point, often provided as belay connection element, to which a safety rope or a carabiner may be connected as a safety device against falling. The belt loop, the leg loop, and an optionally present chest strap may be adjustable to the bodily dimensions of the person to be secured, so that on the one hand forces occurring between the person and the harness are safely transmitted and, on the other hand, it may be prevented that the person to be secured unintentionally slips out of the harness. Harnesses for climbing in the recreation sector and for industrial safety are basically comparable in structure; however, said harnesses must satisfy different standards. While standard EN 12277 is relevant, for example, in the sporting sector, standard EN 361 applies for harnesses for industrial safety and standard EN 358 applies for tethers.

So-called ‘two buckles waistbelt harnesses’ grant to the user great adjustability range and a more symmetrical harness, which results in a more comfortable fit, which is e.g. due to mirrored gear loops and padding. A downside is an increased cost and weight of the harness; at the same time, it has more components subject to possible failures and therefore require more supervision during use. In addition, it is required to adjust two webbings and two buckles at the same length, which typically is an impractical task in the field.

So-called ‘one buckle waistbelt harnesses’ might be lighter, less expensive, safer, and easier to adjust than the two buckle waistbelt harnesses. However, downsides typically include reduced size range, and reduced comfort if the user is not perfectly at the middle of the size range.

This is problematic and affects even the same user, when he/she wears the harness all year long, so with thin clothes during summer and with additional layers during winter season. Last but not least, it is a great disadvantage in case of ‘one-size fit all’ harnesses commonly used in gyms, rope courses, and Via Ferrata.

In the past, harnesses manufacturers tried to solve such problems creating one buckle waistbelt harnesses with sliding paddings that could move over the load bearing sling of the waistbelt. Such solution greatly reduced existing disadvantages but was creating new issues, related to the movement of the paddings during use, e.g. the load bearing structure was static while the user was rolling inside. As the paddings were free to move, other main negative topics were reduced durability, cheap feeling of transmitted to the user, and out of fashion look.

### SUMMARY OF SOME EMBODIMENTS OF THE INVENTION

It is an object of the invention to provide a harness and respective methods involving a harness with enhanced durability, enhanced quality and looks, enhanced adaptability to weather and user comfort, lower cost to produce and enhanced safety. Particularly, it is an object to avoid disadvantages of known harnesses and methods.

The invention is defined by the features of the independent claims. Preferred embodiments are described by the features of the dependent claims.

Particularly, the object is solved by a harness comprising a belt loop, a leg loop, and a belay connection structure. The belay connection structure includes at least one ring-like element, at least one tubular element, and a belay connection element. One of the belt loop and the leg loop may extend together with a circumferential section of the at least one ring-like element through the at least one tubular element. The at least one tubular element may extend along a length that equals more than half of a circumferential length of the at least one ring-like element. The belay connection element may connect or may be configured to connect the belt loop and the leg loop with each other. The belay connection element may extend through the at least one ring-like element.

In other words, particularly, a harness is suggested that includes two loops to surround the user in substantially horizontal planes and one arrangement to connect the two loops. The arrangement is configured with at least one sleeve arranged on at least one of the two loops and additionally with at least one further loop that additionally extends through the at least one sleeve just in a circumferential section of the at least one further loop. It is remarkable that the sleeve extends across more than half of the circumference of the further loop, e.g. so that the sleeve cannot be straightened at all. Thereby, upon tensioning the respective loop of the two loops, the arrangement tensions the at least one further loop, where the arrangement thereby can lock on the loop by way of friction. Vice versa, with the respective loop being slack, an easy adjustment is possible.

The invention suggests with the belay connection structure a sliding bridge which brings a totally new perspective compared to prior art. The user is able to adjust a connection point position between the belt loop and the leg loop to find the best fitting spot his/her size, while all the structures of the belay connection structure, e.g. webbings and paddings, are solidly connected in place. This provides advantages of both ‘two buckles waistbelts harnesses’ and ‘one buckle waistbelt harnesses’. When the harness is properly worn and fit to the user, the tension in the belay connection structure slings itself and will prevent the belay connection structure from moving on its own. This do not create new issues, as the harness behaves similarly to prior art ones.

The proposed harness is particularly applicable for activities where different body positions or adjustments are required during use, for example from standing on a roof to sitting in the harness for climbing a ladder. The harness allows changing its adjustment easily, e.g. in order to fit to different user sizes or when the user needs to twist his body around his vertical axis.

The harness can be used for different indoor and outdoor activities, such as for example climbing, mountaineering, walking, hiking, military purposes, ski touring, via ferrata, tree maintenance, or during professional work activities. The belt loop can also be referred to as hip loop and/or is preferably intended and/or sized for being put around the hip of the person wearing the harness. Equally, the leg loops are preferably intended and/or sized for being put around the legs of the person wearing the harness. The harness can be combined with a chest loop attachable to the belt loop.

The harness provides enhanced safety since the belay connection structure is substantially self-locking when the harness is under tension. This particularly results from the fact that the tubular element is longer than half of the ring-like element's circumference, whereby the tubular element provides friction when the loop also running through the tubular element is pulled on.

A loop, such as the belt loop or the leg loop, may be understood as a belt and/or may be configured to provide a belt for surrounding a user. A loop may comprise an elongated or strap-like element, e.g. with two ends, in order to form the loop in shape, e.g. to be arranged in a substantially circular manner. A loop may comprise connection means in order to form the loop with the elongated or strap-like element and/or in order to adjust a size of the loop. The belay connection structure may be understood as a structure or means for connecting the belt loop and the leg loop with each other, e.g. in a vertical direction. The belay connection structure may secure the belt loop and the leg loop relative to one another. The belay connection structure may be configured to for engaging with one of both the belt loop and the leg loop. The belay connection structure typically engages with or loops through the at least one ring-like element, particularly two thereof.

The at least one ring-like element may be understood as a substantially ring-shaped element or circular element or round element or loop or flexible ring. The at least one tubular element may be understood as a particularly flexible sleeve or tube or containing structure. The at least one tubular element may have an opening or tunnel or passage. The at least one ring-like element may be configured to provide friction relative to the at least one ring-like element and one of the loops, e.g. realized by means of one or more textile materials in contact with one another. The at least one tubular element and the at least one ring-like element may be configured such that the at least one ring-like element can extend in a section of the at least one ring-like element through the at least one tubular element. The at least one tubular element is typically longer than the circumference of the at least one ring-like element. The at least one ring-like element may loop through the at least one tunnel, particularly together and/or in parallel with one of the belt loop and the leg loop.

The circumferential section of the at least one ring-like element extending through the at least one tubular element particularly relates to the arrangement that the at least one ring-like element runs through the at least one tubular element in one section of the at least one ring-like element and runs external to the at least one tubular element in the other section of the at least one ring-like element, the other section extending between the ends of said one section. It may be understood that the at least one tubular element is arranged as a sleeve on the at least one ring-like element, e.g. with the at least one tubular element extending along more than half of the circumference of at least one ring-like element. The at least one ring-like element may be endless with the at least one tubular element mounted movably thereon.

Preferably, the at least one ring-like element comprises a first ring-like element extending through a first tubular element of the at least one tubular element. Preferably, the at least one ring-like element comprises a second ring-like element extending through a second tubular element of the at least one tubular element. The first ring-like element and first tubular element may be arranged adjacent to the belt loop. The second ring-like element and the second tubular element may be arranged adjacent to the leg loop. Particularly, the belay connection structure may exhibit a ring-like element in combination with a tubular element on the ring-like element on each of the leg loop and the belt loop. Thereby, the adjustment in a longitudinal or horizontal direction of the user may be conducted with high flexibility.

Preferably, at least one of the belt loop and the leg loop comprises a flat webbing. Particularly, the belt loop and the leg loop comprise or are substantially formed by means of a flat webbing. Preferably, at least one of the belt loop and the leg loop, particularly both, is/are configured to be adjustable in length and particularly include(s) a free loop end with a thickened structure. The thickened structure may stop on connection means or size adjustment means. As such, the harness can be adapted to a variety of users and can be light. Preferably, the at least one ring-like element and/or the belay connection element is/are configured to be opened and closed. It may be possible that one or both of said elements can be opened/unlocked and then closed/fastened, e.g. for assembly, disassembly, attachment, repair, replacement, putting on the harness, or the like. For example, one or both of said elements may include connection means, like a clip, velcro, a buckle, or the like, to realize this feature.

Preferably, the at least one ring-like element and/or the belay connection element is/are configured to be adjustable in circumferential length or size/diameter. It may be possible that one of both of said elements can be enlarged/widened and reduced/shortened in circumferential length or diameter, e.g. for attachment or putting on the harness or the like. For example, one or both of said elements may include adjustment means or connection means configured for adjustment.

Optionally, the tubular element may be configured to be opened and closed and/or to be adjustable in size/diameter, e.g. as outlined above.

Preferably, the belay connection element comprises a flat webbing. For enhancing strength or flexibility, the belay connection element may comprise a textile material. For example, at least two layers of the flat webbing and/or the textile material may be provided, e.g. the at least two layers coupled and/or sewn together along a circumferential direction. The belay connection element may comprise or consist of a metal material, e.g. a carabiner, a metal ring, or the like. Preferably, the belay connection element is configured to exhibit a fixed or an adjustable circumferential length. For example, the belay connection element may form a closed loop, e.g. not to be opened or changed in length without cutting or damaging it, or in the alternative to be opened or changed in length without cutting or damaging ist. One or more of the above features may be applied to the at least one ring-like element and/or the at least one tubular element.

The belay connection element can be provided as rounded and/or closed belt or strap, which can be worn and/or is textile, for example having a diameter of at least 5 cm and preferably up to 10 cm, and/or as a carabiner, a metal ring and/or a mixture thereof. The belay connection element is for example intended for connecting the harness with a carabiner, a safety device, a lanyard or the like. For example, the belay connection element is fed or passed through the belt loop and/or the leg loop and/or the at least one ring-like element, preferably in a firmly manner allowing a degree of flexibility between the belay connection element and the belt loop and/or the leg loop and/or the at least one ring-like element.

The at least one ring-like element can be provided as rounded and/or closed belt or strap, which can be worn and/or is textile, for example having a diameter of at least 2 cm and preferably up to 8 cm, and/or as a carabiner, a metal ring and/or a mixture thereof. The at least one ring-like element is intended for connection with the belay connection element. The at least one tubular element may substantially secure or connect the at least one ring-like element to the belt loop or leg loop, e.g. among the possibility to provide friction from tension on the respective loop.

Preferably, the at least one ring-like element is configured to exhibit that the circumferential length is fixed. For example, the at least one ring-like element may form a closed loop, e.g. not to be opened or changed in length without cutting or damaging it. In respect to a manufacturing method, the at least one ring-like element may be sewn after having been passed through the at least one tubular element, or the at least one tubular element may be sewn after the at least one tubular element has been placed on the at least one ring-like element. The circumferential length of the at least one ring-like element is particularly more than 51% of a length of the at least one tubular element, particularly at least 60%, 70%, or 80%.

Preferably, the at least one ring-like element comprises a width which is smaller than a width of the respectively adjacent belt loop or leg loop, particularly by at least 5%. Typically, the at least one ring-like element can be slightly narrower than the leg loop or belt loop which can reduce material cost. The at least one ring-like element can thereby also run better together with the leg loop or belt loop through the at least one tubular element, where fixation might be enhanced when tension is applied to the respective belt or leg loop due to this feature.

Preferably, the at least one ring-like element comprises a flat webbing and/or the at least one tubular element is flexible. With the flat webbing and/or the flexibility weight may be reduced by way of choice of material. Also, lifetime may be increased due to possibly less wear of the materials involved.

Preferably, the at least one tubular element forms a tunnel along the length. The tunnel may comprise a substantially constant cross section along the length of the at least one tubular element. The at least one tubular element may comprise a textile material. The at least one tubular element may have a closure section, e.g. a seam, extending along the length of the at least one tubular element. The closure section may close the at least one tubular element on or along a side thereof, e.g. the side extending along the length of the at least one tubular element.

For example, the at least one tubular element may be made from a substantially rectangular material folded over with the longer sides to be connected, e.g. sewn or detachably connected, together. The closure section may be arranged only on one longitudinal side of the at least one tubular element, which may reduce cost to produce or improve maintenance or repair. The closure section can help in production, assembly, disassembly, attachment, repair, replacement, putting on the harness, or the like.

The closure section may include a/the seam particularly as a fixed connection. The closure section may include other fixed connection structures, e.g. is glued, clipped, stapled or the like.

The closure section may be configured to be opened and closed, e.g. for inserting or removing the at least one ring-like element. The closure section may be configured for adjusting the tunnel in diameter, e.g. to change friction manually. The closure section may include a magnet arrangement, a velcro arrangement, a pushbutton arrangement, or the like, particularly as a detachable connection and/or for the tubular element to be configured to be opened and closed or adjusted in diameter.

The magnet arrangement may include a magnetic lock, a ferro-magnetic element, a magnet, and the like arranged along the length. The velcro arrangement may include a velcro fastener e.g. extending along the length. The pushbutton arrangement may include a push-button closure e.g. with a row of pushbuttons along the length.

A diameter of the tunnel may be at least 1 cm and preferably up to 2 cm or 3 cm. A length of the at least one tubular element may be at least 5 cm or at least 8 cm and preferably up to 20 cm.

The object is further solved by a method for adjusting a harness or the harness, particularly the harness worn by a/the user, the belt loop surrounding a belt region of the user and the leg loop surrounding two legs of the user, and/or the belay connection structure connecting the belt loop and the leg loop. The method particularly comprises moving the at least one tubular element along an extension of the belt loop or leg loop and thereby changing the location of a belay connection area relative to the user in the transversal direction of the user, particularly wherein one or both of the belt loop and the leg loop is/are slack.

The method aims to enable an easy adjustment of a harness on a user. The leg or belt loop may be loosened in order to adjust the belay connection structure so that the ring-like element is not under tension, enabling that the tubular element can be moved along the leg or belt loop.

The object is further solved by another method for securing a position of the belay connection structure of a harness or the harness along the transversal direction of a/the user, particularly the harness worn by the user, the belt loop surrounding a/the belt region of the user and the leg loop surrounding two legs of the user, and/or the belay connection structure connecting the belt loop and the leg loop. The another method particularly comprises, optionally in combination with the method, preferably after moving, tightening at least one of the belt loop and the leg loop in the transversal direction of the user and around the user and thereby tightening the at least one ring-like element in the at least one tubular element and fixing the at least one tubular element on the belt loop or leg loop in the transversal direction. The tightening enables that friction is created to act between the leg loop or belt loop, the at least one ring-like element, and the at least one tubular element. Thus, in use, of the belt which typically involves tightening, friction may be automatically created enhancing that the position of the belay connection structure is fixed.

Further advantages and embodiments of the method can be derived from the harness as described before.

Other example embodiments of the invention will be described in the following with reference to the figures. It has to be noted that the figures are only provided for illustration of the general concept of the invention by examples not defining the scope of protection of the invention. The figures are not drawn to scale. Features shall not be considered to be essential for the present invention because they are depicted in the figures.

### BRIEF DESCRIPTION OF THE FIGURES

In the figures

FIG. 1 shows a harness worn by a user and with a belay connection structure connecting a belt loop and a leg loop in a perspective view,

FIGS. 2A-D shows individual parts to form the harness in a schematic view,

FIG. 3 shows a section through the harness, particularly through a loop, a ring-like element, and the tubular element; and

FIGS. 4A-B shows at least one method conducted with the harness in order to secure a position of the belay connection structure with a partially hidden tubular element in a side view.

### DETAILED DESCRIPTION OF THE FIGURES

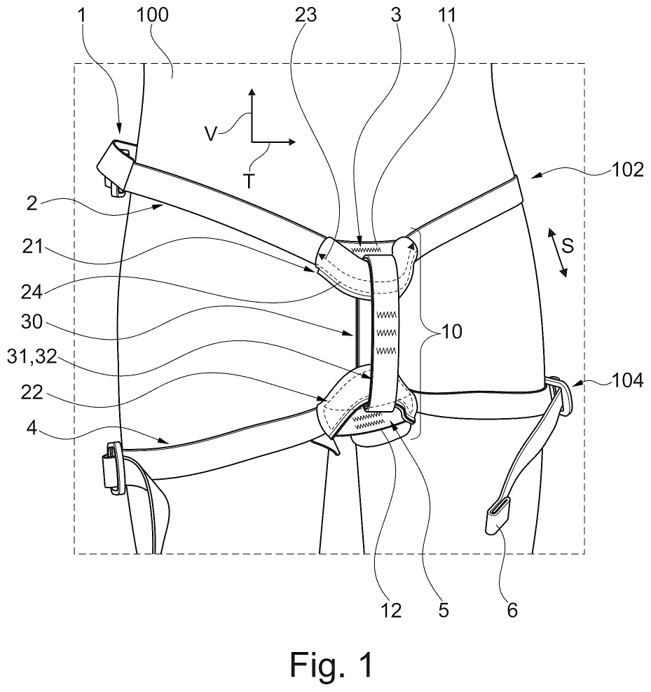

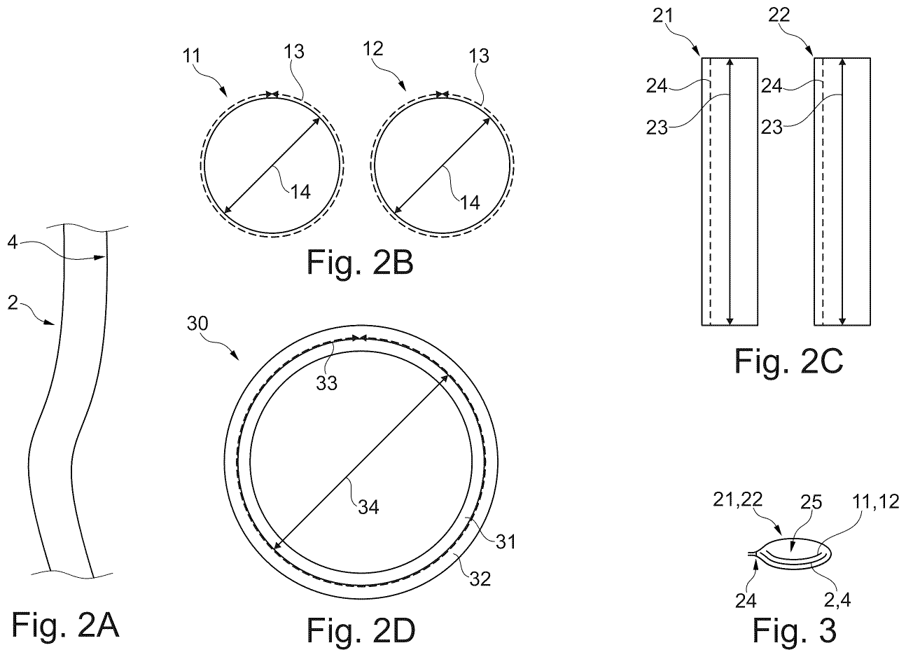

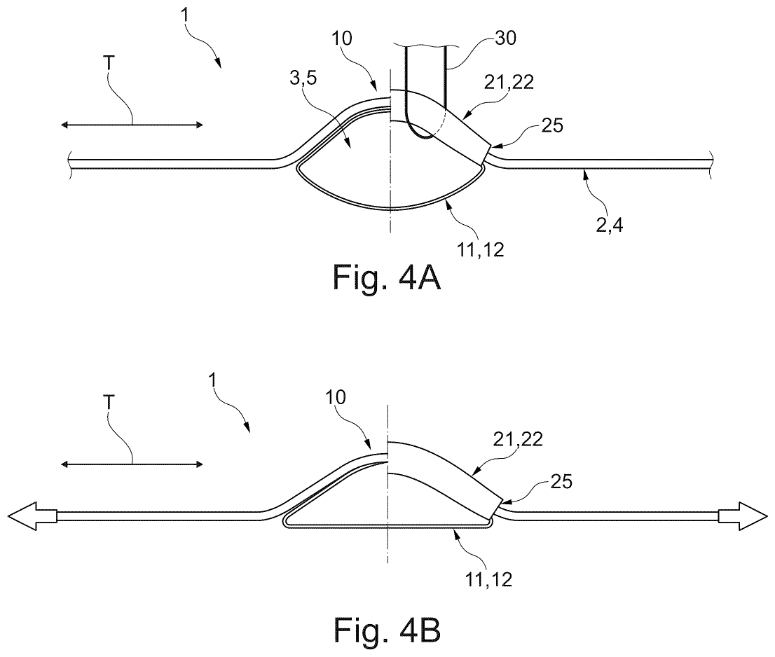

The invention will be described in the following with reference to an exemplary embodiment showing in FIG. 1 a harness 1 worn by a user, in FIG. 2 individual parts of the harness 1, in FIG. 3 a section through the harness 1, and in FIGS. 4A-B at least one method conducted with the harness 1.

FIG. 1 shows a harness 1 worn by a user 100 and comprising a belt loop 2, a leg loop 4, and a belay connection structure 10. The belt loop 2, also referred to as hip loop, is configured for being worn by the user or person around a hip and/or belt. The belay connection structure 10 can be adjusted along a horizontal or transversal direction T of the user, meaning that it can be moved along one or both loops 2, 4.

The belay connection structure 10 includes a first ring-like element 11 and a second ring-like element 12, a first tubular element 21 and a second tubular element 22, and a belay connection element 30 connecting the belt loop 2 and the leg loop 4 with each other and extending through the two ring-like elements 11, 12 and through the two loops 2, 4. Both the belt loop 2 and the leg loop 4 comprises a flat webbing.

In FIG. 1, the belt loop 2 together with a circumferential section of the first ring-like element 11 extend through the first tubular element 21. The leg loop 4 together with a circumferential section of the second ring-like element 12 extend through the second tubular element 22. Thereby, belay connection areas 3 and 5 are formed along the belt loop 2 and leg loop 4, respectively, through which the belay connection element 30 extends. Particularly, the belay connection element 30 extends substantially in a vertical direction V of the user 100.

The transversal T and the vertical V direction are perpendicular to a sagittal direction S.

Both the belt loop 2 and the leg loop 4 are configured to be adjustable in length and include free loop ends 6 with a thickened structure. The thickened structure may stop against a connection means when extending a size of a respective loop 2, 4.

In FIG. 2A, the two loops 2, 4 are shown schematically, as mentioned not to scale.

With respect to FIG. 2B, the ring-like elements 11, 12, which are flexible, are shown when arranged as a circular form.

The circumferential lengths 13 of both ring-like elements 11, 12 may be fixed or may be adjustable for adjusting friction or providing other desired effects.

The ring-like elements 11, 12 and the belay connection element 30 may be configured to be opened and closed and to be adjustable in circumferential length 13 or 33, respectively. For example, connection means may be adopted in each case, e.g. so that respective features can be realized.

The ring-like elements 11, 12 comprise a flat webbing and the tubular elements 21, 22 comprise a textile material and are flexible. The circumferential lengths 13 substantially correspond to a diameter 14 of the ring-like elements 11, 12 multiplied by Pi.

Further, with respect to FIGS. 2B-C, the first tubular element 21 extends along a length 23 that equals more than half of a circumferential length 13 of the first ring-like element 11. The second tubular element 22 extends along a length 23 that equals more than half of a circumferential length 13 of the second ring-like element 12. It can be seen, for example in FIG. 2B and FIG. 2C, that the lengths 23 of the tubular elements 21, 22 is more than half of the circumferential lengths 13 of the ring-like elements 11, 12.

Assuming the drawings in FIGS. 2B-C would be to scale, length 23 divided by diameter 14 and by 3.14 is more than 0.50 and particularly more than 0.60.

FIG. 3 shows a section through the tubular element 21, 22 through which the loop 2,4 and the ring-like element 11, 12 run, e.g. taken from FIG. 1. It can be seen that the loop 2, 4 and the ring-like element 11, 12 are arranged adjacent to one another and stacked atop one another and particularly in contact to one another and/or in contact to the tubular element 21, 22.

With respect to FIG. 2C and FIG. 3, the tubular elements 21, 22 each form a tunnel 25 along the length 23 and comprise a closure section 24 extending along the length 23. The closure sections 24 close the tubular elements 21, 22 on a side thereof. The closure sections 24 may include a seam, a magnet arrangement, or a velcro arrangement.

The closure sections 24, for example with a velcro arrangement, can be opened and closed to insert or remove respective ring-like elements 11, 12 and can be adjusted so that a diameter of the tunnel 25 is changeable.

The closure section 24 is in each case arranged only on one longitudinal side of the respective tubular element 21, 22. The ring-like elements 11, 12 each have a width which is smaller than a width of the respectively adjacent belt loop 2 or leg loop 4, e.g. by at least 5% or by at least 10%.

With respect to FIG. 1 and FIG. 2D, the belay connection element 30 comprises a textile material.

The belay connection element 30 may comprise two layers 31, 32 of a flat webbing. The layers 31, 32 may be sewn together along a circumferential direction of the belay connection element 30.

Alternatively or additionally, the belay connection element 30 and/or the ring-like elements 11, 12 comprise or substantially consist of a metal material such as a carabiner.

The belay connection element 30 may have a fixed circumferential length 33. The belay connection element 30 may be sewed belt.

The belay connection element 30 and the ring-like elements 11, 12 are substantially ring-like element shaped or loop shaped.

The belay connection element 30 is larger in diameter 34 relative to the diameter(s) 14 of one or both ring-like elements 11, 12. Further, a circumferential length 33 of the belay connection element 30 is larger than the circumferential length 13 of one of both ring-like elements 11, 12.

The belay connection element 30 has a larger mechanical strength relative to one or both ring-like elements 11, 12, e.g. can withstand a higher tension or load.

FIGS. 4A-B elucidates methods for adjusting the harness 1 and for securing a position of the belay connection structure 10 when the harness 1 is worn by a user, e.g. when the belt loop 2 surrounds a belt region 102 of the user 100 and the leg loop 4 surrounds two legs 104 of the user 100, particularly cf. FIG. 1.

The belay connection structure 10 may connect the belt loop 2 and the leg loop 4 by means of the belay connection element 30, e.g. as shown in part in FIG. 4A looped through the ring-like element 11 or 12 and around the loop 2 or 4 and the tubular element 21 or 22.

Particularly, FIGS. 4A-B shows an arrangement where the belt loop 2 or leg loop 4 extends through the first tubular element 21 or second tubular element 22, respectively, together with the first ring-like element 11 or second ring-like element 12, respectively. The belay connection region 3 or 5 is formed through which the belay connection element 30 can be engaged therewith, cf. also FIG. 1.

In FIGS. 4A-B, left side, respectively, one half the tubular element 21 or 22 is not shown to give rise how the loop 2 or 4 and the ring-like element 11 or 12 run adjacently to one another in the tunnel 25 of the tubular element 21 or 22.

It can be seen in FIG. 4A that the loop 2 or 4 and particularly the ring-like element 11 or 12 is/are slack, which is for example indicated by the ring-like element 11 or 12 forming a rounding on all sides. In this arrangement, it is possible to move the tubular element 21 or 22 together with the ring-like element 11 or 12 along the extension or length of the loop 2 or 4 thereby changing the location of the belay connection area 3 or 5 relative to the user in the transversal direction T of the user. Thereby, the method related to adjusting the harness 1 can be conducted.

It can be seen in FIG. 4B that the loop 2 or 4 and particularly the ring-like element 11 or 12 is/are tight/tightened or under tension, which is also further indicated by arrows pointing away from respectively shown ends of the loop 2 or 4. In this arrangement, it is substantially impossible to move the tubular element 21 or 22 together with the ring-like element 11 or 12 along the extension of the loop 2 or 4 for changing the location of the belay connection area 3 or 5 in the transversal direction T. This arrangement is achieved by tightening the belt loop 2 or the leg loop 4 in the transversal direction T and thereby tightening the ring-like element 11 or 12 in the tubular element 21 or 22 and fixing the tubular element 21 or 22 on the belt loop 2 or leg loop 4 in the transversal direction T by means of friction.

Particularly, the ring-like element 11 or 12 acts to limit straightening of the belt loop 2 or the leg loop 4, resulting in increased friction between the adjacent materials and a locked structure 10.

The tubular element 21 or 22 cannot fully be straightened due to its length 23 being more than half of the length 13 of the ring-like element 11 or 12.

The harness 1 may be put on by first putting the belt loop 2 around the hip or belt region 102 of the user 100, second the leg loop 4 around the legs 104 of the user. Then, the harness 1 may be adjusted in that the belt connection structure 10 is adjusted, e.g. as described. Then, the harness 1 may be tightened in that the belt loop 2 and the leg loop 4 are tightened which also secures the position of the belay connection structure 10, e.g. as described.

Depicted or described connections between components are generally to be understood to be functional connections. They can be implemented as direct links or as indirect links via several other components. The order of presented actions is not mandatory; alternative orders are possible. It is to be understood that the described embodiments are examples only, which may be modified and/or supplemented in many ways within the scope of the claims. In particular, any feature described for a particular embodiment can be used by itself or in combination with other features in any other embodiment. Each feature that has been described for an embodiment of a particular category can also be used in an equivalent manner in an embodiment of any other category.

### REFERENCE NUMERALS

Harness 1
Belt loop 2
Belay connection area 3
Leg loop 4
Belay connection area 5
Free loop end 6
Belay connection structure 10
First ring-like element 11
Second ring-like element 12
Circumferential length 13
Diameter 14
First tubular element 21
Second tubular element 22
Length 23
Seam 24
Tunnel 25
Belay connection element 30
First layer 31
Second layer 32
Circumferential length 33
Diameter 34
User 100
Belt region 102
Legs 104
Transversal direction T
Sagittal direction S
Vertical direction V

1. A harness comprising a belt loop, a leg loop, and a belay connection structure including:
at least one ring-like element;
at least one tubular element, wherein one of the belt loop and the leg loop together with a circumferential section of the at least one ring-like element extend through the at least one tubular element, and wherein the at least one tubular element extends along a length that equals more than half of a circumferential length of the at least one ring-like element; and
a belay connection element connecting the belt loop and the leg loop with each other and extending through the at least one ring-like element.

2. The harness according to claim 1, wherein:
the at least one ring-like element comprises a first ring-like element extending through a first tubular element of the at least one tubular element, and
the at least one ring-like element comprises a second ring-like element extending through a second tubular element of the at least one tubular element.

3. The harness according to claim 2, wherein at least one of the belt loop or the leg loop comprises a flat webbing.

4. The harness according to claim 1, wherein at least one of the belt loop or the leg loop is configured to be adjustable in length.

5. The harness according to claim 4, wherein at least one of the at least one ring-like element or the belay connection element is configured to be opened and closed.

6. The harness according to claim 1, wherein at least one of the at least one ring-like element or the belay connection element is configured to be adjustable in circumferential length.

7. The harness according to claim 1, wherein the belay connection element comprises at least one of a textile material or a metal material.

8. The harness according to claim 1, wherein the at least one ring-like element comprises a width which is smaller than a width of the respectively adjacent belt loop or leg loop.

9. The harness according to claim 1, wherein:
the at least one ring-like element comprises a flat webbing, and the at least one tubular element is flexible.

10. The harness according to claim 1, wherein the at least one tubular element forms a tunnel along the length and comprises a textile material with a closure section extending along the length, the closure section closing the at least one tubular element on a side.

11. The harness according to claim 10, wherein the closure section is at least one of configured to be opened and closed for inserting or removing the at least one ring-like element and configured for adjusting the tunnel in diameter.

12. A method for adjusting a harness according to claim 1, the harness worn by a user, the belt loop surrounding a belt region of the user and the leg loop surrounding two legs of the user, the belay connection structure connecting the belt loop and the leg loop, the method comprising:
moving the at least one tubular element along an extension of the belt loop or leg loop and thereby changing a location of a belay connection area relative to the user in a transversal direction of the user,
wherein one or both of the belt loop and the leg loop is slack.

13. A method for securing a position of the belay connection structure of a harness according to claim 1 along a transversal direction of a user, the harness worn by the user, the belt loop surrounding a belt region of the user and the leg loop surrounding two legs of the user, the belay connection structure connecting the belt loop and the leg loop, the method comprising:
tightening at least one of the belt loop or the leg loop in the transversal direction of the user and around the user and thereby tightening the at least one ring-like element in the at least one tubular element and fixing the at least one tubular element on the belt loop or leg loop in the transversal direction.

14. The harness according to claim 1, wherein at least one of the belt loop or the leg loop includes a free loop end with a thickened structure.

15. The harness according to claim 14, wherein at least one of the at least one ring-like element or the belay connection element is configured to be opened and closed.

16. The harness according to claim 1, wherein the belay connection element comprises a textile material, wherein at least one of at least two layers of the textile material or a flat webbing are sewn together along a circumferential direction.

17. The harness according to claim 1, wherein the belay connection element comprises a carabiner.

18. The harness according to claim 10, wherein the closure section is arranged only on one longitudinal side of the at least one tubular element and includes a seam, a magnet arrangement or a velcro arrangement.
